(19) United States
(12) Patent Application Publication
(10) Pub. No.: US 2024/0334304 A1
(43) Pub. Date: Oct. 3, 2024

(54) METHODS AND APPARATUS FOR RE-EVALUATING USER-EQUIPMENT ROUTE SELECTION POLICY (URSP) RULE(S) IN A WIRELESS COMMUNICATION SYSTEM

(71) Applicant: Samsung Electronics Co., Ltd., Suwon-si (KR)

(72) Inventors: Koustav ROY, Bangalore (IN); Danish Ehsan HASHMI, Bangalore (IN); Jagadeesh GANDIKOTA, Bangalore (IN); Krishnamurthy D R, Bangalore (IN); Lalith KUMAR, Bangalore (IN)

(21) Appl. No.: 18/618,870

(22) Filed: Mar. 27, 2024

(30) Foreign Application Priority Data
Mar. 27, 2023 (IN) 202341022119
Mar. 13, 2024 (IN) 202341022119

(51) Int. Cl. H04W 40/24; H04W 60/00

(52) U.S. Cl. CPC H04W 40/24; H04W 60/00

(57) ABSTRACT

The disclosure relates to a 5G or 6G communication system for supporting a higher data transmission rate. The principal object of the embodiments herein is to disclose methods and systems for evaluating and re-evaluating a user-equipment route selection policy (URSP) rule in a wireless network. A method for re-evaluating at least one user-equipment route selection policy (URSP) rule in a wireless network, the method comprising: initiating, by a user equipment (UE), re-evaluation of the at least one USRP rule; and checking, by the UE, for a correct Route Selection Descriptor (RSD) for an application, on one of the UE moving to a tracking area (TA) where single-network slice selection assistance information (S-NSSAI) is allowed, and the UE receiving a partially allowed network slice selection assistance information (NSSAI).

### CROSS REFERENCE TO RELATED APPLICATIONS

This application is based on and derives the benefit of Indian Provisional Application No. 202341022119 filed on Mar. 27, 2023, and Indian Non-Provisional application Ser. No. 202341022119 filed on Mar. 13, 2024, the contents of which are incorporated herein by reference.

### BACKGROUND

### 1. Field

Embodiments as disclosed herein relate to wireless communication networks, and more particularly to re-evaluating at least one user-equipment route selection policy (URSP) rule in wireless communication networks by identifying at least one movement of a user equipment (UE) in a tracking area (TA) for checking a correct route selection descriptor (RSD).

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on. In a fifth generation (5G) wireless network, a user equipment (UE) can partially be allowed in a network slice selection assistance information (NSSAI) list, in which the single-network slice selection assistance information (e.g., S-NSSAI-X) is allowed in a tracking area(s) (e.g., TA2) but not in a tracking area(s) (e.g., TA1). An applications (e.g., application−x) operating in the 5G network, the UE may check at least one user-equipment route selection policy (URSP) rule on which the UE can initiate data session (i.e., the URSP rules can be provided by the home operator). The URSP rules can comprise a traffic descriptor (TD) and a route selector descriptor (RSD).

For instance, when an application (−x) is operating in the UE, the UE evaluates at least one URSP rule in a priority order (i.e., increasing order of precedence value). Each URSP rule may have associated precedence value. Lower the precedence value, higher the precedence. The UE evaluates the URSP rule, and on identifying that if the TD matches with the application attributes (i.e., TD-1 matched), the UE can initiate the PDU session with the attributes of RSD (for example, RSD-1, with the PDN-x, S-NSSAI-x) corresponding to the URSP rule of TD-1. However, the UE is in TA-1, in which the UE may not be able to establish protocol data unit (PDU) session on S-NSSAI-X as it is not allowed in the TA-1.

In the existing mechanism, if the other RSD is available in the URSP rule of the matched TD-1, the UE may select another RSD in the URSP rule in low to high precedence value and may try to establish PDU session using the selected attributes, for example, such as RSD-2, RSD-3, and the like in the increasing order of precedence value. Each RSD in the URSP rule may have associated precedence value and lower the precedence value, higher the precedence In another example, if RSD is not available in the TD-1, the UE may move to a lower precedence URSP rule (say URSP rule-2) and check the application attributes with the TD-2 of the URSP rule-2, and on matching application attributes with TD-2, the UE may establish PDU session with the RSD of the URSP rule-2. On identifying that none of the TDs matches, the UE may establish a data session on the default URSP rule. Also, on identifying the unavailability of the default URSP rule, the UE may not be able to establish the PDU session.

Another existing scenario, consider that the UE moves to TA-2 (where the respective S-NSSAI-x is allowed, i.e., the UE is allowed to establish PDU session on RSD-1). However, the UE may end up using the lower precedence RSD-2, or lower precedence URSP rule-2, or default URSP rule, or wherein the UE is unable to establish the PDU session as UE is not taking any action on moving to the TA-2. As the UE does not initiate the PDU session on the higher precedence RSD or URSP rules, which may provide better quality service as TD of the URSP provided by the home public land mobile network (HPLMN) matched with the application attributes so UE continue to use the service available on the inferior URSP rules/RSD. The service level agreement (SLA) may be present between the application and the service provider; hence, application-X may not get special treatment on the lower precedence RSD or lower precedence URSP rule, or on the default URSP rule. If the URSP rule whose TD matching attributes of application-x does not provide service to the application-X, then the application may not be able to get service at all.

Currently, consider that based on the partially allowed NSSAI list, the UE is on the TA, in which the established PDU session is not possible, or the UE establishes a lower priority RSD. The partially allowed NSSAI list is received which can change current TA to the allowed tracking area for the S-NSSAI-x, but the UE is unable to take any action.

Hence, there is a need in the art for solutions which will overcome the above-mentioned drawback(s), among others.

The principal object of the embodiments herein is to disclose methods and systems for evaluating and re-evaluating a user-equipment route selection policy (URSP) rule in wireless communication networks.

Another object of the embodiments herein is to disclose methods and systems for identifying at least one movement of a user equipment (UE) in a tracking area (TA) for checking for a correct route selection descriptor (RSD).

Another object of the embodiments herein is to disclose methods and systems for receiving partially allowed NSSAI with the updated list for initiating URSP re-evaluation to check the correct RSD for an application.

### SUMMARY

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

The embodiment discloses a method for re-evaluating at least one user-equipment route selection policy (URSP) rule in a wireless network, the method comprising initiating, by a user equipment (UE), re-evaluation of the at least one USRP rule; and checking, by the UE, for a correct route selection descriptor (RSD) for an application, on one of the UE moving to a tracking area (TA) where single-network slice selection assistance information (S-NSSAI) is allowed, and the UE receiving a partially allowed network slice selection assistance information (NSSAI) or partially rejected NSSAI.

The embodiments disclose a user equipment (UE) comprising: a processor; a memory; and wherein the processor is configured to: initiate re-evaluation of the at least one URSP rule; and check for a correct route selection descriptor (RSD) for an application, on one of move to a tracking area (TA) where single-network slice selection assistance information (S-NSSAI) is allowed, and receive a partially allowed network slice selection assistance information (NSSAI) or partially rejected NSSAI.

A method performed by a terminal in a wireless communication system, the method comprising: transmitting, to an access and mobility management function (AMF), a registration request message comprising information on a requested network slice; receiving, from the AMF, a registration accept message comprising at least one of information on a partially allowed network slice, or information on a partially rejected network slice; identifying whether the information on the partially allowed network slice is changed, or whether current tracking area identifier (TAI) is in a list of tracking areas (TAs) for which information on a network slice is allowed; and in case that the information on the partially allowed network slice is changed, or the current TAI is in the list of the TAs for which the information on the network slice is allowed, performing an evaluation of user equipment route selection policy (URSP). The method further comprises: based on at least one of the information on the partially allowed network slice, or the information on the partially rejected network slice, identifying whether the current TAI is in the list of the TAs for which the information on the network slice is allowed. Wherein the information on the partially allowed network slice is partially allowed network slice selection assistance information (NSSAI), wherein the information on the partially rejected network slice is single network slice selection assistance information (S-NSSAI) rejected partially, wherein the information on the network slice is S-NSSAI, and wherein the performing the evaluation of the URSP comprises performing a re-evaluation of the URSP.

A method performed by an access and mobility management function (AMF) in a wireless communication system, the method comprising: receiving, from a terminal, a registration request message comprising information on a requested network slice; and transmitting, to the terminal, a registration accept message comprising at least one of information on a partially allowed network slice, or information on a partially rejected network slice; wherein, in case that the information on the partially allowed network slice is changed, or current tracking area identifier (TAI) is in a list of tracking areas (TAs) for which information on a network slice is allowed, an evaluation of user equipment route selection policy (URSP) is performed.

A terminal in a wireless communication system, the terminal comprising: a transceiver; and at least one processor coupled with the transceiver and configured to: transmit, to an access and mobility management function (AMF), a registration request message comprising information on a requested network slice, receive, from the AMF, a registration accept message comprising at least one of information on a partially allowed network slice, or information on a partially rejected network slice, identify whether the information on the partially allowed network slice is changed, or whether current tracking area identifier (TAI) is in a list of tracking areas (TAs) for which information on a network slice is allowed, and in case that the information on the partially allowed network slice is changed, or the current TAI is in the list of the TAs for which the information on the network slice is allowed, perform an evaluation of user equipment route selection policy (URSP).

An access and mobility management function (AMF) in a wireless communication system, the AMF comprising: a transceiver; and at least one processor coupled with the transceiver and configured to: receive, from a terminal, a registration request message comprising information on a requested network slice, and transmit, to the terminal, a registration accept message comprising at least one of information on a partially allowed network slice, or information on a partially rejected network slice, wherein, in case that the information on the partially allowed network slice is changed, or current tracking area identifier (TAI) is in a list of tracking areas (TAs) for which information on a network slice is allowed, an evaluation of user equipment route selection policy (URSP) is performed.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the following drawings. Embodiments herein are illustrated by way of examples in the accompanying drawings, and in which:

FIG. 1 illustrates a flow diagram of a method for re-evaluating at least one URSP in a wireless network according to embodiments of the present disclosure;

FIG. 2 illustrates an example of interaction of a UE with a network function entity according to embodiments of the present disclosure; and

FIG. 3 illustrates a flow diagram of a method for re-evaluating at least one URSP in a wireless network according to embodiments of the present disclosure.

### DETAILED DESCRIPTION

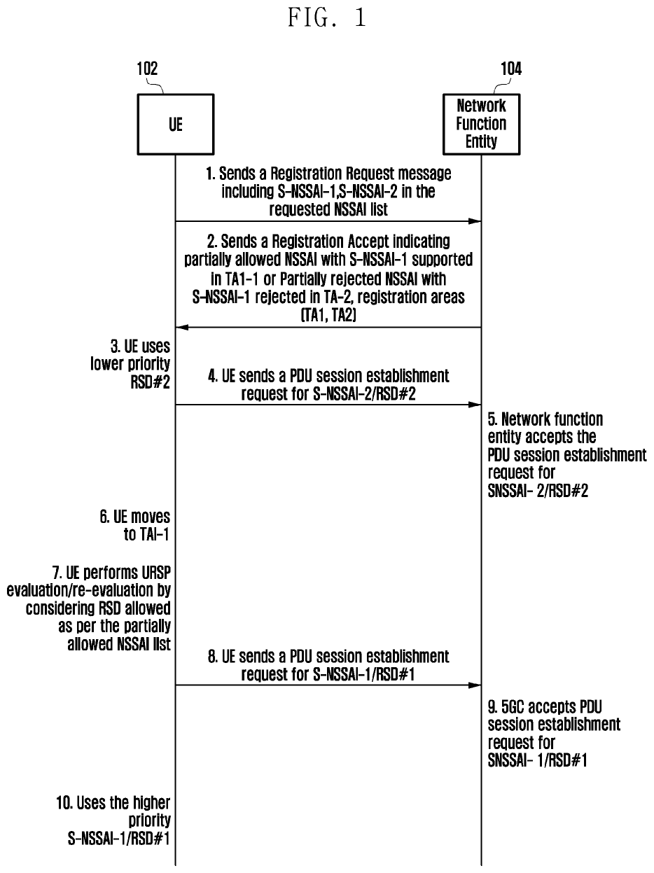

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising,” “having” and “including” are to be construed as open-ended terms unless otherwise noted.

The words/phrases “exemplary,” “example,” “illustration,” “in an instance,” “and the like,” “and so on,” “etc.,” “etcetera,” “e.g.,” “i.e.,” are merely used herein to mean “serving as an example, instance, or illustration.” Any embodiment or implementation of the present subject matter described herein using the words/phrases “exemplary,” “example,” “illustration,” “in an instance,” “and the like,” “and so on,” “etc.,” “etcetera,” “e.g.,” “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

Embodiments herein disclose methods and systems for re-evaluating at least one user-equipment route selection policy (URSP) in wireless communication networks. Referring now to the drawings, and more particularly to FIGS. 1 through 3, where similar reference characters denote corresponding features consistently throughout the figures, there are shown at least one embodiment.

Fifth generation (5G) wireless network involves the selection of optimal data or the route for managing the user data traffic between the UE and the network through the 5G core network (5GC), user-equipment route selection policy (URSP) plays a crucial role in determining the transmission and routing of the user data within the network, ensuring efficient and reliable data delivery. The key aspects of URSP include data path selection, policy-based decision making, mobility considerations, dynamic path selection, and so on.

The URSP can be used to select the most suitable data path or route for managing the data traffic between the UE and the external data network (DN). The URSP makes decisions based on factors such as, but not limited to, network conditions, traffic load, and quality of service (QOS) requirements. URSP operates based on pre-defined policies and rules configured by the network operator. These policies define the criteria(s) for selecting the data path, considering factors such as, but not limited to, latency, bandwidth, cost, or specific service requirements.

Further, on selecting a particular route, the URSP considers the mobility of the UE. As the UE moves within the network, the URSP can re-evaluate and update the data path to ensure continuous connectivity and efficient data delivery. Also, the URSP can dynamically adapt to changing network conditions and traffic patterns. The URSP can continuously monitor the network performance and may trigger route changes upon identifying that the current path is congested and experiencing degradation.

In the 5G Core Network, the URSP operates in conjunction with network functions and entities to ensure effective data routing. An access and mobility management function (AMF) may provide the URSP with mobility-related information about the UE. The AMF can influence the route selection based on the current location and the mobility status of the UE.

The URSP is an essential aspect of the 5G networks, responsible for selecting the optimal data path or the route for the user data traffic between the UE and the external data network (DN) through the 5G Core Network. Therefore, by making policy-based decisions and considering factors such as QoS, mobility, and network conditions, URSP can ensure efficient and reliable data delivery while optimizing network resource usage. The URSP can play a significant role in delivering a seamless user experience and supporting various services in 5G networks.

FIG. 1 illustrates a flow diagram of a method for re-evaluating at least one user-equipment route selection policy (URSP) in wireless communication networks. As illustrated in FIG. 1, a user equipment (UE) 102 can move to a tracking area (TA) where single-network slice selection assistance information (S-NSSAI) is allowed. The UE can determine that the S-NSSAI is allowed based on at least one of a partially allowed NSSAI list, or a rejected partially allowed NSSAI list.

Further, on determining that the UE has moved to the TA, the UE can re-evaluate the URSP to re-determine the association of the application to the RSD. Further, the UE can identify that the UE has been moved to the TA where the S-NSSAI is allowed based on the partially allowed NSSAI list stored in the UE The UE may receive partially allowed NSSAI in the registration accept or configuration update command NAS message In an embodiment herein, the UE may re-evaluate the URSP, on the UE on receiving a new partially allowed NSSAI list with changes or updates. Consider that the UE can identify that the that UE is able to establish a PDU session on the high precedence RSD-1, based on the URSP re-evaluation. The UE can then move data related to an application-X (which is an application that is currently running and/or active on the UE) to a protocol data unit (PDU) session established with the attributes of RSD-1 (i.e., UE associate application-x to the PDU session established with attribute of the RSD-1).

Consider the UE has the URSP rule with S-NSSAI-1 in RSD-1 and S-NSSAI-2 is in the RSD-2 in the same URSP rule. The RSD-1 has higher precedence than the RSD-2.

The UE can send a registration request message including S-NSSAI-1, S-NSSAI-2 in the requested NSSAI list to a network function entity. Examples of the network function entity can be, but not limited to, the access and mobility management function (AMF), a session management function (SMF), the data network (DN), and the like. The network function entity can send a registration accept message including the S-NSSAI-1 in partially allowed NSSAI list, indicating the supported list of tracking areas (TAs) as tracking area Identifier (TAI-1) and current registration areas (including TAI-1 and TAI-2). Supported list of tracking areas (TAs) is also referred as a partial tracking area identity list.

On identifying that the UE is in TAI-2 and determining that route selection descriptor (RSD-1)/S-NSSAI-1 are not allowed in TAI-2, the UE uses a lower precedence RSD-2. Also, the UE can send the PDU session establishment request for S-NSSAI-2/RSD-2 to the 5GC, and the 5GC can accept the PDU session establishment request for S-NSSAI-2/RSD-2.

On the UE moving to TAI-1, the UE can perform URSP evaluation/re-evaluation by considering the RSDs which are owed based on the partially allowed NSSAI list. Here, the RSD-1/S-NSSAI-1 has higher priority than the currently used RSD-2.

The UE can send a PDU session establishment request for S-NSSAI-1/RSD-1 to the 5GC, and the 5GC can accept the PDU session establishment request for S-NSSAI-1/RSD-1.

Consider that a lower priority RSD is used. In step 1, the UE sends a registration request message including S-NSSAI-1, S-NSSAI-2 in the requested NSSAI list to the network function entity. In step 2, the network function entity sends a registration accept (including S-NSSAI-1 in the partially allowed NSSAI list), indicating a supported list of TAs as TAI-1 and current registration areas (that includes TAI-1 and TAI-2). Consider that the UE is in TAI-2, and that the RSD #1/S-NSSAI-1 not allowed in TAI-2. In step 3, the UE uses lower priority RSD #2. In step 4, the UE sends a PDU session establishment request for S-NSSAI-2/RSD #2 to the network function entity (i.e., the 5GC). In step 5, the network function entity accepts the PDU session establishment request for S-NSSAI-2/RSD #2. In step 6, the UE moves to TAI-1. In step 7, the UE performs URSP evaluation/re-evaluation by considering the RSD which are allowed as per the partially allowed NSSAI list (as provided in step 2). Consider that the RSD #1/S-NSSAI-1 has a higher priority than the currently used RSD #2. In step 8, the UE sends a PDU session establishment request for S-NSSAI-1/RSD #1. In step 9, the 5GC accepts PDU session establishment request for S-NSSAI-1/RSD #1. In step 10, the UE uses the higher priority S-NSSAI-1/RSD #1 for the application-x. i.e. Upon URSP re-evaluation/evaluation, UE associate the application-x to the PDU session established with attributes of RSD-1.

Consider that a lower priority RSD is used. In step 1, the UE sends a registration request message including S-NSSAI-1, S-NSSAI-2 in the requested NSSAI list to the network function entity. In step 2, the network function entity sends a registration accept (including S-NSSAI-1 in the partially rejected NSSAI list), indicating a list of TAs where S-NSSAI-1 is rejected as TAI-2 and current registration areas (that includes TAI-1 and TAI-2). Consider that the UE is in TAI-2, and that the RSD #1/S-NSSAI-1 not allowed in TAI-2. In step 3, the UE uses lower priority RSD #2. In step 4, the UE sends a PDU session establishment request for S-NSSAI-2/RSD #2 to the network function entity (i.e., the 5GC). In step 5, the network function entity accepts the PDU session establishment request for S-NSSAI-2/RSD #2. In step 6, the UE moves to TAI-1. In step 7, the UE performs URSP evaluation/re-evaluation by considering the RSD which are allowed as per the partially rejected NSSAI list (as provided in step 2). Consider that the RSD #1/S-NSSAI-1 has a higher priority than the currently used RSD #2. In step 8, UE initiate registration procedure, include S-NSSAI-1 in the requested NSSAI, if network include S-NSSAI-1 in the allowed NSSAI, the UE sends a PDU session establishment request for S-NSSAI-1/RSD #1. In step 9, the 5GC accepts PDU session establishment request for S-NSSAI-1/RSD #1. In step 10, the UE uses the higher priority S-NSSAI-1/RSD #1 for the application-x. i.e. Upon URSP re-evaluation/evaluation, UE associate the application-x to the PDU session established with attributes of RSD-1.

Consider that the UE enters a TAI, wherein support of the TAI has been indicated in a given S-NSSAI. In an embodiment herein, the UE can enter the TAI from another TAI where the UE was not supported. Optionally, if a PDU session of that S-NSSAI is active, the UE can trigger URSP evaluation/re-evaluation, based on the information available in the partially allowed NSSAI list or the S-NSSAIs rejected partially in the routing area (RA).

In an embodiment herein, the UE may perform evaluation/re-evaluation of URSP if at least one of the below lists is updated:
if the update is for a S-NSSAI included in the partially allowed NSSAI whose related PDU session is active;
if the current TAI does not support the required S-NSSAI; and
partially allowed NSSAI is changed or partially rejected NSSAI is changed or network slice area of service (NS-AoS) information is changed.

In an embodiment herein, the UE may perform evaluation/re-evaluation of URSP if UE move to TA or cell:
if S-NSSAI is in the partially allowed S-NSSAI and UE NAS layer indicates that current TAI is in the list of TAs for which the S-NSSAI is allowed;
if S-NSSAI is in the partially rejected S-NSSAI and UE NAS layer indicates that current TAI is in the list of TAs for which the S-NSSAI is not rejected; and
If S-NSSAI is in the S-NSSAI location validity information and current cell (location) is in the NS-AoS of the S-NSSAI (i.e., UE NAS layer indicates that current cell is in NS-AoS of the S-NSSAI).

The list includes partially allowed NSSAI list, or the S-NSSAIs rejected partially in the routing area (RA), or S-NSSAI location availability information.

In an embodiment herein, for a network slicing (NS)-area of service (AOS), when a UE enters a cell indicating a support of a given S-NSSAI (from a cell where the UE was not supported, or if the PDU session of that S-NSSAI is active), the UE may trigger URSP evaluation/re-evaluation, based on the information available in the S-NSSAI (i.e., location availability information).

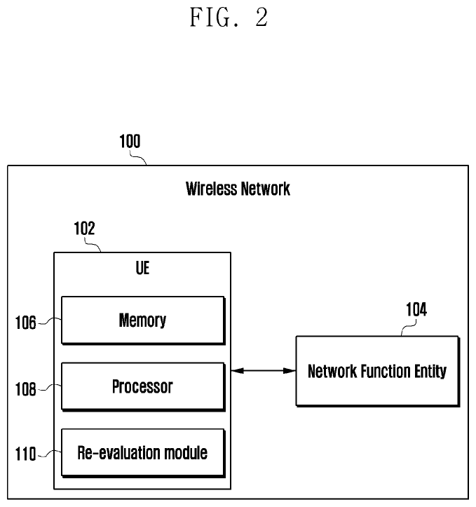

FIG. 2 illustrates an example of interaction of a user equipment (UE) with a network function entity, according to embodiments as disclosed herein. As depicted in FIG. 2, the wireless network 100 comprises the UE 102 and at least one network function entity 104. The wireless network 100 referred to herein can be at least one of, but not limited to, a 3rd generation partnership project (3GPP) network, a virtualized RAN a long-term evolution (LTE)/4G network, an LTE advanced network, a fifth generation/new radio (5G) network, a 5G based wireless communication system, a 4G based wireless communication system, a centimeter-wave 5G network, and so on.

The UE 102 can be a device configured to connect to the wireless network 100. In an embodiment herein, the UE 102 can be a stand-alone device. The UE 102 can be integrated with another device such as, but not limited to, a mobile phone, a smartphone, a tablet, a phablet, a personal digital assistant (PDA), a computer, a laptop, a phone, an Internet of Things (IoT) device, a wearable device, a virtual reality (VR) device, a vehicle infotainment system, a connected vehicle, and so on.

The UE 102 may include a memory 106, a processor 108, and a re-evaluation module 110. The re-evaluation module 110 can be implemented as a software module or a hardware circuit in the UE 102. The re-evaluation module 110 is not limited to the specific software module or hardware circuit. The UE 102 can have access to the memory 106 for fetching information related to queries received from the user. In addition, the UE 102 may further connect to at least one of a cloud, a dedicated user interaction device cloud, a server and so on using at least one communication network for accessing information related to the queries received from the user.

The memory 106 can be configured to store the communication/interaction performed between the UE 102 and the network function entity 104.

The memory 106 may include one or more computer-readable storage media. The memory 106 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 106 may, in some examples, be considered as a non-transitory storage medium. The term “non-transitory” may indicate that the storage medium is not embodied in a carrier wave or a propagated signal. However, the term “non-transitory” should not be interpreted to mean that the memory 106 is non-movable. In some examples, the memory 106 can be configured to store larger amounts of information than the memory. In certain examples, a non-transitory storage medium may store data that can, over time, change (e.g., in random access memory (RAM) or cache).

The processor 108 can be at least one of a single processer, a plurality of processors, multiple homogeneous or heterogeneous cores, multiple CPUs of different kinds, special media, and other accelerators. Further, the plurality of processing units may be located on a single chip or over multiple chips. The memory 106 can include a program code/program instruction that can be executed on the processor 108 to execute one or more steps for performing encryption at the UE 102.

The UE 102 can move to a tracking area (TA) where single-network slice selection assistance information (S-NSSAI) is allowed. The UE 102 can determine that the allowed S-NSSAI is based on partially allowed NSSAI list or the rejected partially allowed list.

On determining that the UE 102 has moved to the TA, the re-evaluation module 110 can perform the URSP re-evaluation to re-determine the association of the application to the RSD. The re-evaluation module 110 can perform URSP re-evaluation and on identifying that the UE 102 is able to establish a protocol data unit (PDU) session on the high precedence RSD-1, data of the application−X can be moved to the PDU session, which has been established with the attributes of RSD-1. On the UE 102 receiving a new partially allowed NSSAI list with changes and/or updates, the re-evaluation module 110 can perform URSP re-evaluation.

Consider that the UE 102 has moved to the TA where the S-NSSAI is allowed. The UE 102 can receive the partially allowed NSSAI with a list that has been changed/updated. The re-evaluation module 110 can check the correct RSD for the application-X based on the received partially allowed NSSAI.

The re-evaluation module 110 can initiate the URSP re-evaluation and check for the correct RSD of the application. The re-evaluation module 110 can identify that the UE has been moved to the TA where the S-NSSAI is allowed. The re-evaluation module 110 can receive partially allowed NSSAI based on the updated/changed list.

In the 5GCN, the URSP operates in conjunction with the network functions and entities to ensure effective data routing. Examples of the network function entity 110 can be, but are not limited to, an access and mobility management function (AMF), a session management function (SMF), a data network (DN), and the like. In an example herein, the AMF, serving as a network function entity may provide the URSP with mobility-related information about the UE 102, which can influence the route selection based on the current location and the mobility status of the UE 102.

Further, a policy control function (PCF) can update the URSP, the NAS layer of the UE 102 can indicate that the UE is successfully registered in N1 mode over at least one third generation partnership project (3GPP) access, and non-third generation partnership project (3GPP) access, indicate partially allowed, partially rejected, NS-AoS information to the URSP layer.

Therefore, each of the partially allowed NSSAIs can be stored in the UE 102 as a set composed of NSSAIs and a list of TAs for which S-NSSAI is supported. Also, upon receiving the partially rejected NSSAI, the UE 102 can store the received partially rejected NSSAI. The UE 102 may not attempt to include the S-NSSAI in the requested NSSAI, if the current TAI is in the list of TAs for which the S-NSSAI is rejected.

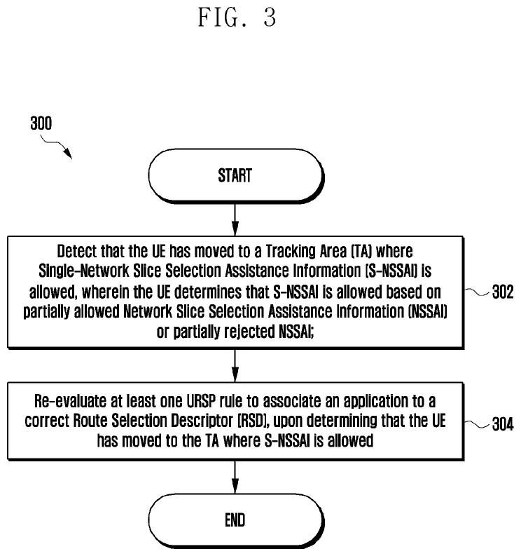

FIG. 3 illustrates a flow diagram of method for re-evaluating at least one user-equipment route selection policy (URSP) in a wireless network. At step 302, the method includes, detecting, by a user equipment (UE), that the UE has moved to a tracking area (TA) where single-network slice selection assistance information (S-NSSAI) is allowed, wherein the UE determines that S-NSSAI is allowed based on partially allowed network slice selection assistance information (NSSAI) or partially rejected NSSAI. At step 304, the method includes, re-evaluating, by the UE, at least one URSP rule to associate an application to a correct Route Selection Descriptor (RSD), upon determining that the UE has moved to the TA where S-NSSAI is allowed. The various actions in method 300 may be performed in the order presented, in a different order or simultaneously. Further, in some embodiments, some actions listed in FIG. 3 may be omitted.

The embodiments disclosed herein can be implemented through at least one software program running on at least one hardware device and performing network management functions to control the network elements. The elements include blocks which can be at least one of a hardware device, or a combination of hardware device and software module.

The embodiment disclosed herein describes a circuit for performing analog calibration for a scalable multi-voltage memory interface driver. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high-speed integrated circuit hardware description language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the present disclosure may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
transmitting, to an access and mobility management function (AMF), a registration request message comprising information on a requested network slice;
receiving, from the AMF, a registration accept message comprising at least one of information on a partially allowed network slice, or information on a partially rejected network slice;
identifying whether the information on the partially allowed network slice is changed, or whether current tracking area identifier (TAI) is in a list of tracking areas (TAs) for which information on a network slice is allowed; and
in case that the information on the partially allowed network slice is changed, or the current TAI is in the list of the TAs for which the information on the network slice is allowed, performing an evaluation of user equipment route selection policy (URSP).

2. The method of claim 1, further comprising:
based on at least one of the information on the partially allowed network slice, or the information on the partially rejected network slice, identifying whether the current TAI is in the list of the TAs for which the information on the network slice is allowed.

3. The method of claim 1, wherein the information on the partially allowed network slice is partially allowed network slice selection assistance information (NSSAI),
wherein the information on the partially rejected network slice is single network slice selection assistance information (S-NSSAI) rejected partially, and
wherein the information on the network slice is S-NSSAI.

4. The method of claim 1, wherein the performing the evaluation of the URSP comprises performing a re-evaluation of the URSP.

5. A method performed by an access and mobility management function (AMF) in a wireless communication system, the method comprising:
receiving, from a terminal, a registration request message comprising information on a requested network slice; and
transmitting, to the terminal, a registration accept message comprising at least one of information on a partially allowed network slice, or information on a partially rejected network slice,
wherein, in case that the information on the partially allowed network slice is changed, or current tracking area identifier (TAI) is in a list of tracking areas (TAs) for which information on a network slice is allowed, an evaluation of user equipment route selection policy (URSP) is performed.

6. The method of claim 5, wherein whether the current TAI is in the list of the TAs for which the information on the network slice is allowed is based on at least one of the information on the partially allowed network slice, or the information on the partially rejected network slice.

7. The method of claim 5, wherein the information on the partially allowed network slice is partially allowed network slice selection assistance information (NSSAI),
wherein the information on the partially rejected network slice is single network slice selection assistance information (S-NSSAI) rejected partially,
wherein the information on the network slice is S-NSSAI, and
wherein the evaluation of the URSP comprises a re-evaluation of the URSP.

8. A terminal in a wireless communication system, the terminal comprising:
a transceiver; and
at least one processor coupled with the transceiver and configured to:
transmit, to an access and mobility management function (AMF), a registration request message comprising information on a requested network slice,
receive, from the AMF, a registration accept message comprising at least one of information on a partially allowed network slice, or information on a partially rejected network slice,
identify whether the information on the partially allowed network slice is changed, or whether current tracking area identifier (TAI) is in a list of tracking areas (TAs) for which information on a network slice is allowed, and
in case that the information on the partially allowed network slice is changed, or the current TAI is in the list of the TAs for which the information on the network slice is allowed, perform an evaluation of user equipment route selection policy (URSP).

9. The terminal of claim 8, wherein the at least one processor is configured to:
based on at least one of the information on the partially allowed network slice, or the information on the partially rejected network slice, identify whether the current TAI is in the list of the TAs for which the information on the network slice is allowed.

10. The terminal of claim 8, wherein the information on the partially allowed network slice is partially allowed network slice selection assistance information (NSSAI),
wherein the information on the partially rejected network slice is single network slice selection assistance information (S-NSSAI) rejected partially, and
wherein the information on the network slice is S-NSSAI.

11. The terminal of claim 8, wherein the performing the evaluation of the URSP comprises performing a re-evaluation of the URSP.

12. An access and mobility management function (AMF) in a wireless communication system, the AMF comprising:
a transceiver; and
at least one processor coupled with the transceiver and configured to:
receive, from a terminal, a registration request message comprising information on a requested network slice, and
transmit, to the terminal, a registration accept message comprising at least one of information on a partially allowed network slice, or information on a partially rejected network slice,
wherein, in case that the information on the partially allowed network slice is changed, or current tracking area identifier (TAI) is in a list of tracking areas (TAs) for which information on a network slice is allowed, an evaluation of user equipment route selection policy (URSP) is performed.

13. The AMF of claim 12, wherein whether the current TAI is in the list of the TAs for which the information on the network slice is allowed is based on at least one of the information on the partially allowed network slice, or the information on the partially rejected network slice.

14. The AMF of claim 12, wherein the information on the partially allowed network slice is partially allowed network slice selection assistance information (NSSAI),
wherein the information on the partially rejected network slice is single network slice selection assistance information (S-NSSAI) rejected partially, and
wherein the information on the network slice is S-NSSAI.

15. The AMF of claim 12, wherein the evaluation of the URSP comprises a re-evaluation of the URSP.
